(19) United States
(12) Patent Application Publication
(10) Pub. No.: US 2015/0115895 A1
(43) Pub. Date: Apr. 30, 2015

(54) SYSTEM AND METHOD OF DISCHARGING HIGH-VOLTAGE BATTERY

(71) Applicant: Hyundai Motor Company, Seoul (KR)

(72) Inventor: Hyung Soo Kim, Seoul (KR)

(73) Assignee: HYUNDAI MOTOR COMPANY, Seoul (KR)

(21) Appl. No.: 14/308,180

(22) Filed: Jun. 18, 2014

(30) Foreign Application Priority Data
Oct. 24, 2013 (KR) 10-2013-0127288

(51) Int. Cl. B60L 11/18; H02J 7/00

(52) U.S. Cl. CPC B60L 11/1864; H02J 7/0029; H02J 7/0063; H02J 2007/0067
USPC 320/136

(57) ABSTRACT

A method of discharging a high-voltage battery is provided. The method includes demounting a communication connector of a battery management system (BMS) and connecting the BMS communication connector and a discharge system to enable communication between the BMS and the discharge system. Additionally, the method includes discharging the battery using the discharge system.

### CROSS-REFERENCE(S) TO RELATED ED APPLICATION

This application claims priority of Korean Patent Application No. 10-2013-0127288 filed on Oct. 24, 2013, in the Korean Intellectual Property Office, which is hereby incorporated by reference in its entirety.

### BACKGROUND

1. Field of the Invention

The present invention relates, in general, to a system and method of discharging a high-voltage battery that prevents a possible accident caused by remaining electric energy when the high-voltage battery is demounted from a vehicle.

2. Description of the Related Art

For hybrid electric vehicles (HEVs) and electric vehicles (EVs), a high-voltage battery is typically mounted therein. When the high-voltage battery of these types of vehicles has to be replaced, the high-voltage battery is demounted. Even when the high-voltage battery is in a discharged state, residual electric energy remains in the battery at a predetermined level. Nevertheless, the high-voltage battery is demounted from the vehicle, and the demounted high-voltage battery is immersed into salt water when discharged. To discharge the demounted high-voltage battery, the salt water should be separately prepared/removed. Since the high-voltage battery is immersed into the prepared salt water when discharged, workability is substantially low. The salt water contaminates components of the high-voltage battery, and thus the components cannot be recycled. Further, since the salt water used to discharge the high-voltage battery should be subjected to waste-water treatment, treatment expenses are incurred and environmental pollution may occur.

Accordingly, in the related art the battery is charged/discharged using information regarding a charged state sent from a battery management system (BMS) of the EV. The method of charging/discharging the battery includes a step of a charger receiving a charge rate according to a time zone and a charge allowable time for charging the battery of the EV, a step of determining charge power according to the time zone to charge the battery based on the charge rate according to the time zone and the charge allowable time, and a step of adjusting the charge of the battery using the charge power according to the time zone.

However, the method of charging/discharging the battery fails to ensure safety of a worker when the high-voltage battery is demounted, to improve workability, to reduce the environmental pollution during working, and to sufficiently secure the recycling of components. Accordingly, there is a need for an eco-friendly method of discharging a high-voltage battery which sufficiently secures the safety of a worker, does not cause environmental pollution, and can recycle resources.

The foregoing is intended merely to aid in the understanding of the background of the present invention, and is not intended to mean that the present invention falls within the purview of the related art that is already known to those skilled in the art.

### SUMMARY

Accordingly, the present invention provides an eco-friendly method of discharging a high-voltage battery, capable of sufficiently securing safety of a worker, and recycling resources without causing environmental pollution.

According to one aspect of the present invention, a method of discharging a high-voltage battery may include: demounting a communication connector of a battery management system (BMS) and connecting the BMS communication connector and a discharge system to enable communication between the BMS and the discharge system; and discharging the battery using the discharge system. In particular, the method may further include disconnecting a high-voltage cable from a hybrid power control unit (HPCU) prior to the connecting of the BMS communication connector and the discharge system when a vehicle is a hybrid electric vehicle, and connecting the high-voltage cable to the discharge system.

Further, a safety plug may be demounted prior to the connecting of the BMS communication connector and the discharge system, and may be mounted prior to the discharging of the battery. In addition, in connection of the BMS communication connector and the discharge system, the BMS may be supplied with power from the discharge system via a communication line, and may send a value of present voltage to the discharge system. In the connection of the BMS communication connector and the discharge system, the BMS and the discharge system may be configured to transceive data, recognize that a vehicle is in a virtual operation state, and operate a power relay assembly (PRA).

The method may further include connecting a rapid charge terminal and the discharge system after the connecting of the BMS communication connector and the discharge system when a vehicle is an electric vehicle (EV). Further, in the connection of the BMS communication connector and the discharge system, the BMS and the discharge system may be configured to transceive data, recognize that a vehicle is in a rapidly charged state, and operate a power relay assembly (PRA) and a quick charging relay assembly (QRA), and power of the high-voltage battery may be supplied to the discharge system through a rapid charge terminal. In addition, the method may further include terminating the discharging of the battery when a voltage of the battery is less than a predetermined value.

According to the method of discharging the high-voltage battery as described above, the high-voltage battery of the HEV or the EV may be subject to the on-vehicle discharge. Accordingly, the discharge may be performed before the high-voltage battery is demounted. Therefore, it may not be necessary to prepare salt water, and equipment (heavy equipment such as a hoist or a forklift) to place the high-voltage battery into or out of a salt water bath may be omitted, thus increasing the convenience of the worker. Since the battery may be discharged before it is demounted, safety may be improved compared to the related art in which the battery that is not discharged is demounted and immersed into the salt water, and waste water used to discharge the battery is not generated. As such, the method of discharging the battery is eco-friendly, and time and effort of the worker maybe reduced.

Further, in the related art, the high-voltage battery is immersed into the salt water when discharged, and thus components of the high-voltage battery may be corroded by the salt water. In particular, a recycling value of the battery may decrease, and thus the recycling rate may decrease. However, in the method of discharging the high-voltage battery according to the present invention, the recycling rate of the battery may be improved since no corrosion of the components of the battery may occur, and cost saving and environmental protection may be achieved.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary flow chart showing a method of discharging a high-voltage battery of a hybrid electric vehicle (HEV) according to an exemplary embodiment of the present invention;

FIG. 2 shows an exemplary configuration in which the HEV and a discharge system are connected according to an exemplary embodiment of the present invention;

FIG. 3 shows an exemplary display of the discharge system according to an exemplary embodiment of the present invention;

FIG. 4 shows an exemplary micro-discharger mounted on the battery after the battery is discharged according to an exemplary embodiment of the present invention;

FIG. 5 is an exemplary graph showing discharge test results of the HEV according to an exemplary embodiment of the present invention;

FIG. 6 is an exemplary table showing an operation of the vehicle according to a percentage (%) of a state of charge (SOC) according to an exemplary embodiment of the present invention;

FIG. 7 is an exemplary flow chart showing a method of discharging a high-voltage battery of an electric vehicle (EV) according to another exemplary embodiment of the present invention;

FIG. 8 shows an exemplary configuration in which the EV and a discharge system are connected according to an exemplary embodiment of the present invention; and

FIG. 9 is an exemplary graph showing discharge test results of the EV according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinbelow, a method of discharging a high-voltage battery according to an exemplary embodiment of the present invention will be described in detail with reference to the accompanying drawings. In the method of discharging the high-voltage battery according to the present invention, an example in which a vehicle is a hybrid electric vehicle (HEV) and an example in which a vehicle is an electric vehicle (EV) will be described in that order. In addition, the method may be performed by a processor or a robot configured to executed particular program instructions.

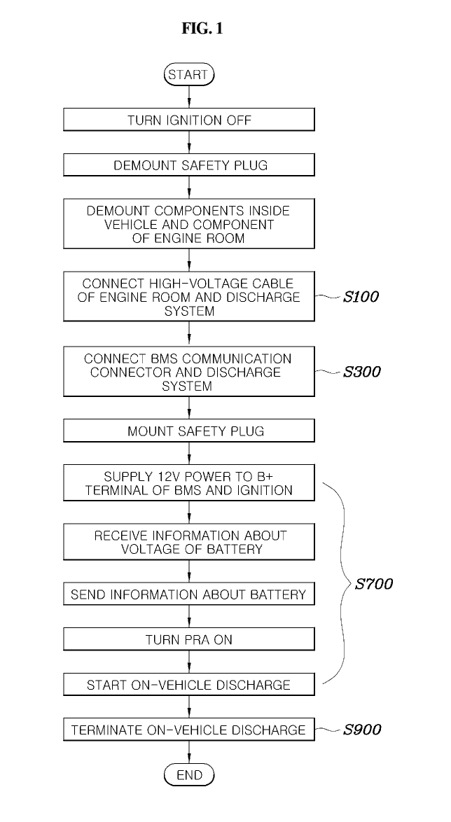

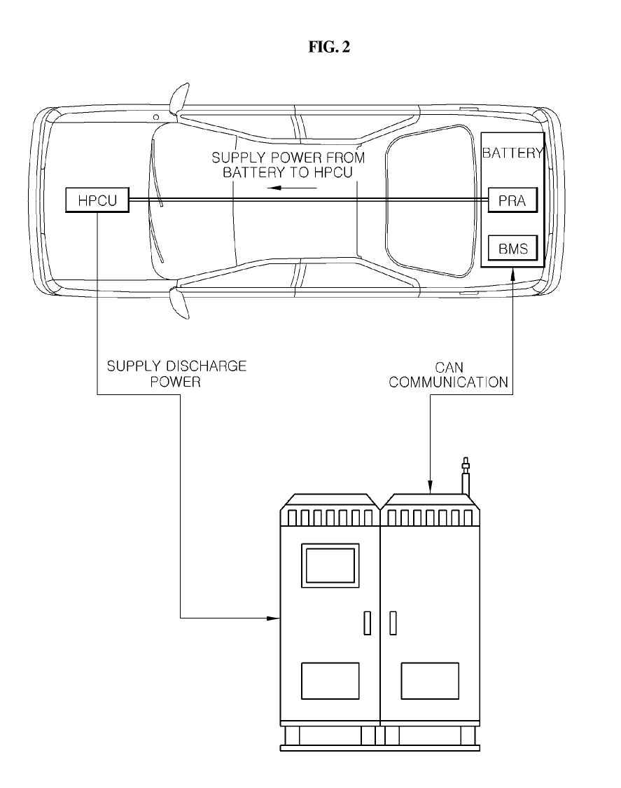

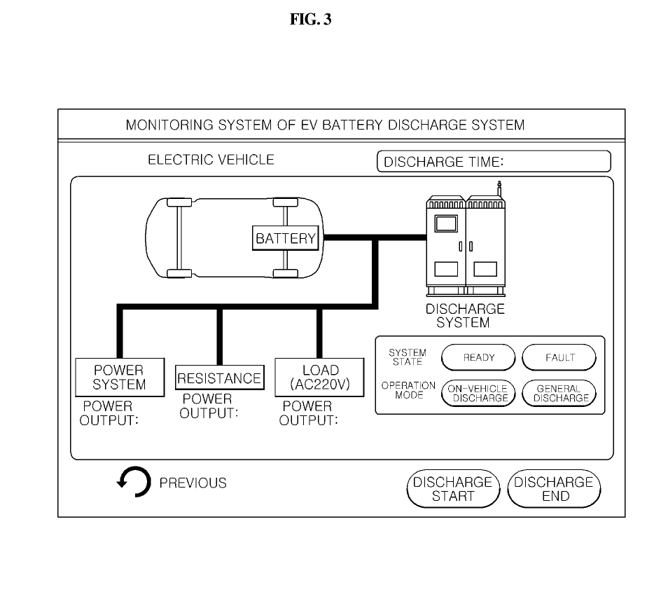

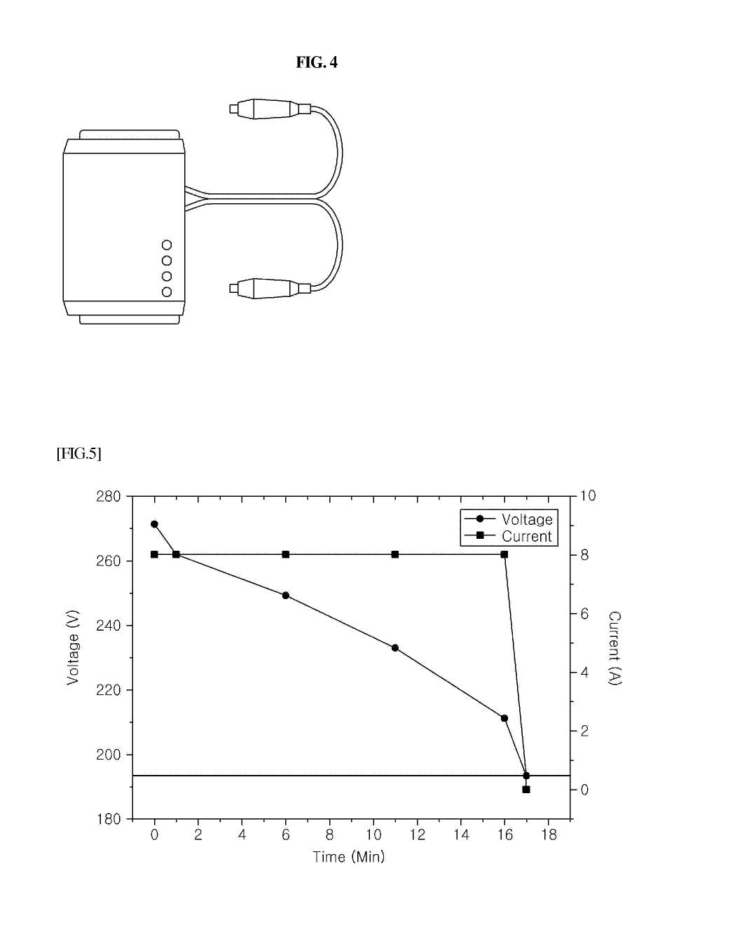

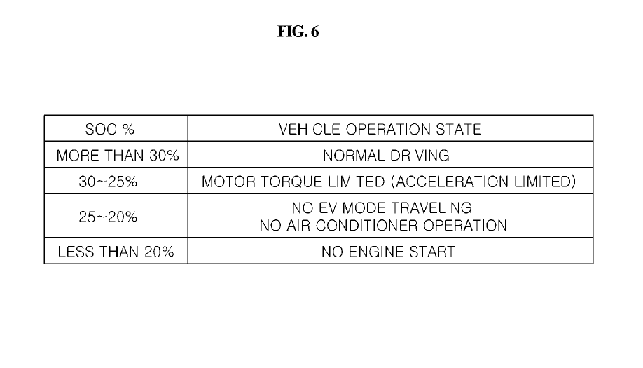

First, the example in which the vehicle is the HEV will be described. FIG. 1 is an exemplary flow chart showing a method of discharging a high-voltage battery of an HEV according to an exemplary embodiment of the present invention. FIG. 2 shows an exemplary configuration in which the HEV and a discharge system are connected. FIG. 3 shows an exemplary display of the discharge system. FIG. 4 shows an exemplary micro-discharger mounted on the battery after the battery is discharged. FIG. 5 is an exemplary graph showing discharge test results of the HEV. FIG. 6 is an exemplary table showing an operation of the vehicle according to a percentage (%) of a state of charge (SOC).

There may not be access to power of a battery from the exterior since the HEV may not be equipped with an external charge terminal. In other words, the battery may not be charged from the exterior. To discharge the battery, an access to a power circuit of the battery within the vehicle must be present, and a location having the easiest access from the exterior by minimum component disassembly may be selected. Such conditions may be met by a high-voltage cable connected to a hybrid power control unit (HPCU) mounted within an engine room.

Accordingly, the method of discharging the high-voltage battery according to the exemplary embodiment of the present invention may include demounting a communication connector of a battery management system (BMS) and connecting the BMS communication connector and a discharge system to enable communication between the BMS and the discharge system (S300), and discharging the battery using the discharge system (S700). However, to discharge the battery of the vehicle, before step S300 is performed, a worker may turn off the ignition of the vehicle, wear insulating gloves, and remove a safety plug located in a trunk. The safety plug is one of safety mechanisms of the HEV that interrupts a high voltage flowing to the vehicle. The safety of the worker may be secured from unexpected accidents by demounting the safety plug.

Further, in step S300, the BMS communication connector and the discharge system may be connected. In the HEV, the BMS communication connector may be disposed at a lower end of a rear surface of a rear seat. Accordingly, the BMS communication connector may be exposed for the connection to the discharge system. Therefore, a rear pillar trim and the rear seat may be previously demounted. Likewise, the HPCU of the engine room and the discharge system may be connected. Accordingly, in the engine room, the worker may demount an air cleaner and an air intake, detect a high-voltage cable indicated by an orange color, demount the high-voltage cable connected to the HPCU, and connect the demounted high-voltage cable and the discharge system (S100).

After the worker connects the high-voltage cable, the worker may disconnect the BMS communication connector, exposed to the rear surface of the rear seat of the vehicle, from the BMS, connect the BMS communication connector and the discharge system to enable the communication between the BMS and the discharge system (S300). After the BMS communication connector and the discharge system are connected, the demounted safety plug may be mounted to cause electric current to flow to the within of the vehicle.

To fetch electric energy from the battery, a power relay assembly (PRA) of the battery may be operated. As such, main relays (+) and (−) of the PRA may be connected. However, since the PRA may be operated when the vehicle is in an operable state, the PRA may not be operated when the ignition is turned off as in the present situation. Accordingly, to operate the PRA, the BMS may be configured to detect as if the vehicle were in operation by converting the vehicle into a virtual operation state. Accordingly, in step S300, the BMS may be supplied with power from the discharge system via a communication line, and may be configured to transmit a value of present voltage to the discharge system. This may be processed by communication between the vehicle and the discharge system. Details may vary depending on design or type of the vehicle.

First, when the BMS communication connector and the discharge system are connected, the power may be supplied to the BMS. In particular, power of about 12 V may be supplied to a BMS power supply terminal and the ignition from the discharge system via the communication line. After the power is supplied to the BMS, the BMS may be configured to transmit the value of present voltage to the discharge system. Then, the discharge system may be configured to transmit predetermined data values to the BMS. The BMS receiving the data values may be configured to detect that the vehicle is in the virtual operation state, and may be configured to operate the PRA acting as a switch between the battery and the high-voltage cable. When the PRA is operated, the power may be supplied from the battery to the HPCU via the high-voltage cable. Since the high-voltage cable of the HPCU and the discharge system may be connected, the battery may be discharged without being demounted. In particular, the worker may operate a display of the discharge system of FIG. 3, to discharge the battery on the vehicle using the discharge system without demounting the high-voltage battery from the vehicle (S700).

FIG. 5 is an exemplary graph showing on-vehicle discharge test results of the HEV. When on-vehicle discharge is performed without demounting the high-voltage battery of the HEV using the method of discharging the high-voltage battery, changes of voltage and current over time are shown. As shown in FIG. 5 the on-vehicle discharge may be sufficiently possible without demounting the battery. In particular, for the HEV, when a cell voltage is less than about 1.5 V (or when a pack voltage is less than about 144 V), a cell protecting function of the battery may be activated to turn off the PRA, and the on-vehicle discharge may be terminated. When the cell protecting function is inactivated, the on-vehicle discharge may be possible up to about 0 V. However, a result of the test shows that even when the battery is discharged up to a point of time when the cell protecting function is activated, the ignition of the engine may not be possible.

FIG. 6 is an exemplary table showing an operation state of the vehicle according to a percentage (%) of a state of charge (SOC). The table in FIG. 6 shows that when the ignition of the engine is not possible, the SOC of the high-voltage battery may indicate less than about 20%, and the battery may be sufficiently discharged. When the voltage of the battery is reduced below a predetermined value by performing step S700 as described above, the discharge may be terminated (S900), and the steps for the on-vehicle discharge of the battery may be terminated.

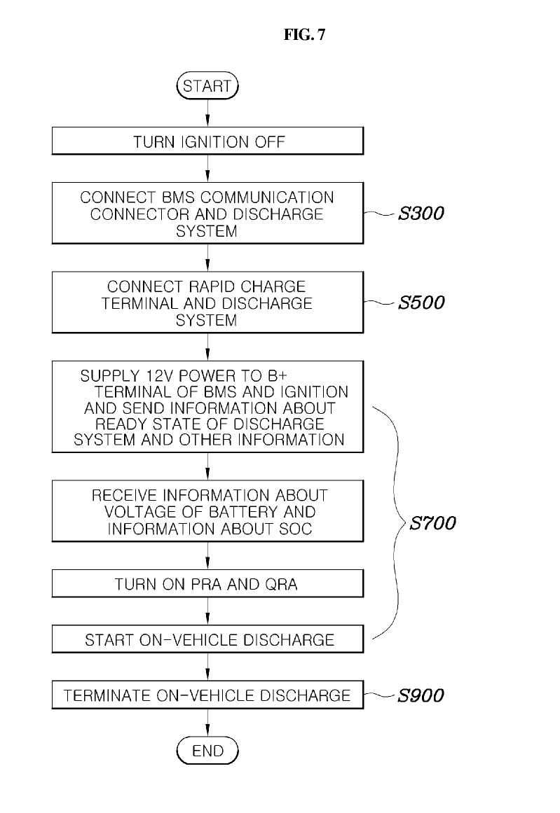

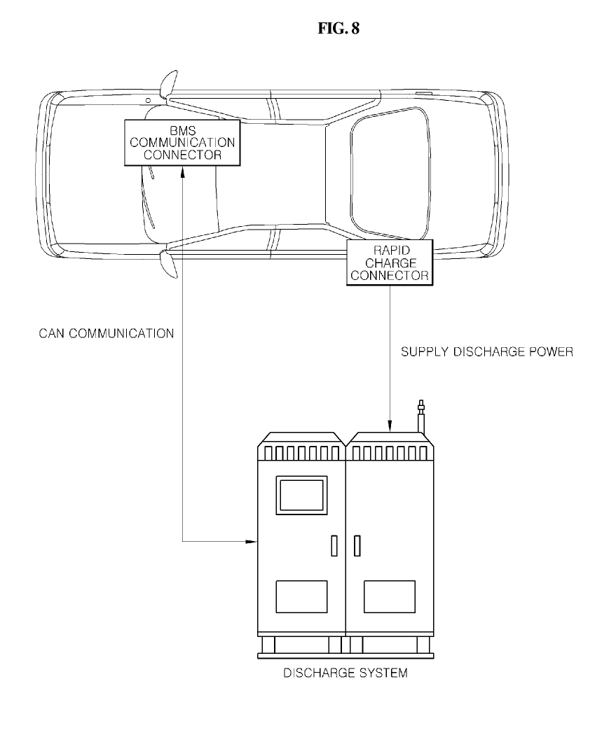

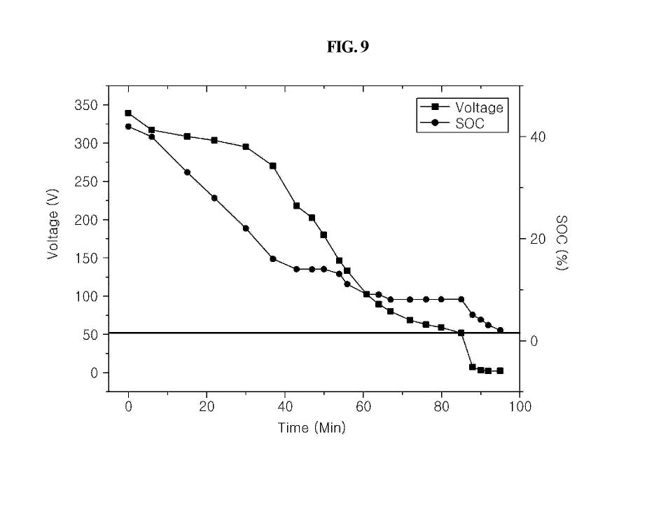

FIG. 7 is an exemplary flow chart showing a method of discharging a high-voltage battery of an EV according to another exemplary embodiment of the present invention, and FIG. 8 shows an exemplary configuration in which the EV and a discharge system are connected. When a vehicle is an EV, the method of discharging the high-voltage battery may include demounting a communication connector of a BMS, and connecting the BMS communication connector and a discharge system to enable communication between the BMS and the discharge system (S300), and discharging the battery using the discharge system (S700).

In the method of discharging the high-voltage battery according to the other exemplary embodiment of the present invention, in step S300, the BMS communication connector may be demounted, and then the BMS communication connector and the discharge system may be connected to enable the communication between the BMS and the discharge system. In step S700, the battery may be discharged by the discharge system. Further, like the HEV, to perform on-vehicle discharge of the high-voltage battery of the EV, a worker may turn off the ignition of the EV, disconnect BMS communication connector disposed at a lower end of a passenger seat, connect the BMS communication connector and the discharge system to enable the communication between the BMS and the discharge system (S300). Afterwards, a charge terminal may be connected (S500) and in particular, a rapid charge terminal may be connected to the discharge system.

In the case of the EV, two charge terminals may be provided, one of which may be a slow charge terminal disposed in the front of the vehicle, and the other of which may be a rapid charge terminal disposed in a fuel filler neck Both of the charge terminals may be used for the present invention. The discharge using the rapid charge terminal may provide improved work convenience for the worker and easier access to the circuit aspect of the vehicle. As such, the on-vehicle discharge may be performed using the rapid charge terminal To perform the on-vehicle discharge, the charge terminal of the vehicle may be connected to the discharge system (S500). Accordingly, after step S500 may be performed, the BMS and the discharge system may communicate to transceive predetermined data similar to the HEV.

When the BMS communication connector and the discharge system are connected, power may be supplied to the BMS. Accordingly, the discharge system may be configured to supply power of about 12 V to a BMS power supply terminal and the ignition via a communication line thereof, and may be configured to transmit information regarding a ready state thereof and other information. The BMS supplied with the power may be configured to transmit a value of present voltage of the battery and SOC information to the discharge system. When this data communication is performed, the BMS may be configured to detect that the vehicle is in a rapid charge state, and turn on a PRA and a quick charging relay assembly (QRA). When the QRA is turned on, the power of the high-voltage battery may be supplied to the discharge system via the rapid charge terminal. Thus, the worker may operate a display of the discharge system more easily without demounting the battery from the vehicle, and thus discharging the high-voltage battery using the discharge system on the vehicle (S700).

FIG. 9 is an exemplary graph showing discharge test results of the EV. When the on-vehicle discharge is performed without demounting the high-voltage battery of the EV, changes of voltage and current over time are shown. The graph of FIG. 9 shows that the on-vehicle discharge may be possible. Particularly, in the case of the EV, when a cell voltage is less than about 2 V (or when a pack voltage is less than about 176 V), a cell protecting function of the battery may be activated and the PRA may be turned of As a result, the power supplied to the engine room may be interrupted. However, since the QRA may remain turned on, even when the cell protecting function of the BMS is activated, an on-vehicle discharge up to about 0 V may be possible.

As described above, when the voltage of the battery is reduced below a predetermined value in step S700 of the HEV or the EV, the discharge may be terminated (S900), and the control may be terminated. In step S900, the worker may detect the discharge state of the battery on the display of the discharge system. Further, since the remaining voltage of the battery in the event of the final discharge may be set and determined by the worker, the worker may set the remaining voltage as desired. When the remaining voltage reaches a voltage set by the worker, the discharged may be terminated.

As shown in FIGS. 5 and 9, the voltages of the high-voltage batteries before the discharge are different according to the state of each battery. As a result of the test, the voltage of the battery before the discharge ranges from about 230 V to 270 V for the HEV, and ranges from about 330 V to 350 V for the EV. The discharged state of the battery may be detected by monitoring a value of current and a drop state of voltage when the battery is discharged. For the EV, a value of the SOC during the discharge may be additionally detected. When the battery is discharged in a constant current mode, a constant current flows in the early stage of the discharge, and voltage may decrease. As the discharge proceeds, an amount of the flowing current may be reduced, and a drop speed of the voltage may decrease. However, even when the discharge is terminated, the voltages of the batteries may remain different according to each battery, but then may be increased to some extent. As such, when the discharge is completed, the micro-discharger shown in FIG. 4 may be mounted on the discharged battery to remove a voltage increase effect, to minimize the electric energy in the battery.

As described above, the high-voltage battery of the HEV or the EV may be subject to the on-vehicle discharge. Therefore, the discharge may be performed before the high-voltage battery is demounted. Therefore, the preparation salt water may be omitted, and equipment (heavy equipment such as a hoist or a forklift) for placing the high-voltage battery into or out of a salt water bath may be omitted, thus increasing the convenience of the worker.

Accordingly, since the battery may be discharged before it is demounted, safety may be improved compared to the related art in which the battery that is not discharged is demounted and immersed into the salt water, and waste water used to discharge the battery is not generated. Therefore, the method of discharging the battery is eco-friendly, and time and effort of the worker may be decreased. Further, in the related art, the high-voltage battery is immersed into the salt water when discharged, and thus components of the high-voltage battery are corroded by the salt water. In particular, a recycling value of the battery is reduced, and thus the recycling rate is reduced. However, in the method of discharging the high-voltage battery according to the present invention, the recycling rate of the battery may be improved since corrosion of the components of the battery may be prevented, and cost saving and environmental protection may be achieved.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of discharging a high-voltage battery, comprising:
demounting a communication connector of a battery management system (BMS) and connecting the BMS communication connector and a discharge system to enable communication between the BMS and the discharge system; and
discharging the battery using the discharge system.

2. The method according to claim 1, further comprising:
disconnecting a high-voltage cable from a hybrid power control unit (HPCU) prior to connecting the BMS communication connector and the discharge system when a vehicle is a hybrid electric vehicle; and
connecting the high-voltage cable to the discharge system.

3. The method according to claim 1, wherein a safety plug is demounted prior to connecting the BMS communication connector and the discharge system, and is mounted prior to discharging the battery.

4. The method according to claim 1, wherein, in the connection of the BMS communication connector and the discharge system, the BMS is supplied with power from the discharge system via a communication line, and is configured to transmit a value of present voltage to the discharge system.

5. The method according to claim 1, wherein, in the connection of the BMS communication connector and the discharge system, the BMS and the discharge system are configured to transceive data, detect that a vehicle is in a virtual operation state, and operate a power relay assembly (PRA).

6. The method according to claim 1, further comprising:
connecting a rapid charge terminal and the discharge system after connecting the BMS communication connector and the discharge system when a vehicle is an electric vehicle (EV).

7. The method according to claim 1, wherein, in the connection of the BMS communication connector and the discharge system, the BMS and the discharge system are configured to transceive data, detect that a vehicle is in a rapidly charged state, and operate a power relay assembly (PRA) and a quick charging relay assembly (QRA), and power of the high-voltage battery is supplied to the discharge system using a rapid charge terminal.

8. The method according to claim 1, further comprising:
terminating the discharging of the battery when a voltage of the battery is less than a predetermined value.
